(19) United States
(12) Patent Application Publication
(10) Pub. No.: US 2026/0233235 A1
(43) Pub. Date: Aug. 13, 2026

(54) SUSTAINABLE SYSTEM FOR PROCESSING FINE TAILINGS FROM MINING, LOW-HARDNESS MINERALS AND INDUSTRIAL, ELECTRONIC AND CONSTRUCTION WASTE, AND PRODUCTS OBTAINED THEREFROM

(71) Applicant: GEOAGRO CONSULTORIA PROJECTOS E SERVICIOS LTDA, Sao Paulo (BR)

(72) Inventor: Alexandre Orlandi Passos, Sao Paulo (BR)

(73) Assignee: GEOAGRO CONSULTORIA PROJECTOS E SERVICIOS LTDA, Sao Paulo (BR)

(21) Appl. No.: 17/756,981

(22) PCT Filed: Dec. 11, 2020
(86) PCT No.: PCT/BR2020/050535

§ 371 Date: Jun. 9, 2025

(30) Foreign Application Priority Data
Dec. 11, 2019 (BR) BR102019 026219 2

(51) Int. Cl. B03B 9/06

(52) U.S. Cl. CPC B03B 9/061

(57) ABSTRACT

The invention relates to a sustainable system for processing fine tailings from mining, low-hardness minerals and industrial, electronic and construction waste, and products obtained therefrom, for application in the processing of fine tailings from mining, and also for the processing of low-hardness minerals and for the treatment of industrial, electronic and construction waste. This novel design consists of the incorporation of technologies around high-efficiency grinding mills with circulation of hot gases that can raise the process temperature to values of up to 750° C., and pre-concentration systems. This solution makes it possible to improve the recovery of materials of interest, usually metals, and further to promote the pozzolanic activation of the remaining material. This activation will depend on the material and the temperature, and the parameters of the process will be defined taking into account the process and application requirements of the products.

### TECHNICAL FIELD OF THE INVENTION

This Invention patent refers to a sustainable system for processing fine mining waste, low-hardness ores and industrial, electronic and construction waste, as well as the respective products obtained from this system, which aims to use most or all of the fine mining waste, as well as industrial, electronic and construction waste, in order to transform environmental liabilities stored in dams, piles or landfills into products that can contribute to the sustainable development of the region affected by mining or industrial, electronic and construction waste.

This new processing system is based on the integration of technologies applied for various purposes and that make it possible to overcome operational and financial limitations for the use of these materials. In addition, increasingly restrictive environmental requirements make it essential to develop sustainable approaches for the treatment of waste and residues. These technologies and their associated benefits are presented below:
i. Oil well stimulator, which is silicon/polymer, which in diluted form acts as a surfactant. This chemical product is non-toxic and safe for those who handle it and for the environment. It acts by reducing tensions between solid and liquid material, thus facilitating the dewatering of very fine materials in high-performance centrifuges.
ii. Integrated mills with hot gas generators, bottom extractors and pneumatic separators, which work at process temperatures of up to 750° C. and accept feed with up to 40% humidity. These systems allow working with pulps, enabling partial or total pozzolanic activation of clay minerals and microsilica and pre-concentration in a single piece of equipment, with high energy efficiency. The higher temperature adds value to the material by turning it into a cementitious material and also by acting on minerals of economic interest, altering their crystalline structure. Pre-concentration reduces the volume to be processed in the next steps, making it easier to concentrate and decontaminate the calcined mass by metals. This technology is the major differentiator for the new processing concept, where the material is heated and selectively micro-pulverized (only particles with hardness lower than seven on the Mohz scale) before concentration, with the aim of adding value to the gangue and contributing to the release and separation of minerals and metallic materials.
iii. Ultrasonic magnetism stimulation system. This type of technology can be an alternative to facilitate the magnetic separation of some minerals without the need for temperatures above 450° C., which is the temperature limit for pendulum mills integrated with hot gas systems. Depending on the mineralogical composition and the potential use of waste and residues in the region, this can be an interesting alternative from an operational and economic perspective.
iv. High-intensity magnetic separation system for fine and dry materials. This type of technology can enable the concentration of minerals of economic interest, or the decontamination of the pre-concentrated mass, with low investment and reduced operating costs.
v. Electrostatic or Tribo-Electrostatic Separation. This type of technology can enable the concentration of minerals of economic interest, or the decontamination of the pre-concentrated mass, with low investment and reduced operating costs.

The definition of which technologies should be integrated for each application depends on an assessment of the material to be processed, the associated mineral assets of economic interest and the region where the calcined mass will be used. However, it is certain that mills integrated with hot gas generators that work with process temperatures of up to 750° C., which accept feed with up to 40% humidity and perform pre-concentration, bring a series of new possibilities for the use of fine mining waste, as well as low-hardness ores and industrial, electronic and construction waste.

### BACKGROUND OF THE INVENTION

Large quantities of mining waste are conventionally disposed of in dams because they are the lowest cost option. However, this alternative has a high environmental impact because it practically renders the area where it is installed unusable, in addition to posing a high risk of rupture due to the large accumulation of material and the constant need for maintenance, especially when mining activities in that region have ceased. Fine waste has characteristics that must be taken into account in order to properly understand the problem:
i. Fine mining waste usually has a high concentration of the mineral that was the object of extraction or of contaminants, which makes it difficult to use it in the market;
ii. The accumulation of pockets with fine material contributes to increasing the geotechnical risks associated with storage structures;
iii. The clay minerals and microsilica that make up a large part of fine mining waste can be used as cement or as pozzolan, depending on regional demand;
iv. Limestone, which makes up another large part of fine mining waste, can be used as soil improvers, as a material for civil construction and industrial applications, depending on the quality of the material and regional demand.

Another alternative that has been applied is the stacking of waste. However, this process has a higher operating cost and, despite eliminating the risk of dam rupture, the high environmental impact remains due to the impossibility of using the area where the stacked waste deposit is located, as well as the environmental risks associated with erosion of unconsolidated material and fugitive dust.

The most interesting alternative for the disposal of fine mining waste is the recovery of the mineral assets contained or the decontamination of fine waste, allowing the transformation of the remainder into co-products or even into binders to improve the geotechnical stabilization of the waste piles at more competitive costs than those of dams.

The same concepts can be applied to the processing of low-hardness ores and industrial, electronic and construction waste, where the recovery of mineral assets and the use of the remainder in the region as a co-product should be considered.

Thus, the Applicant of the present invention patent developed the sustainable system for processing fine mining waste, low-hardness ores and industrial, electronic and construction waste, now disclosed, providing the following contributions for the disposal of this waste:
i. The recovery of minerals of interest and the generation of cementitious by-products will provide a new scenario, contributing to regional development and to changing the relationship between mining and local society. Furthermore, this invention complements traditional mineral processing systems, allowing the continuity of operations of existing projects with the implementation of tailings treatment systems that enable their use, thus eliminating the risks and impacts associated with tailings deposits. The by-products can be used for various applications, such as:
a. Improving the geotechnical stability of stacked tailings deposits, generating solid structures that can be used in the future;
b. Building structures to protect mining dams and for water management;
c. Production of blocks, paving stones and precast elements.
ii. The implementation of water management structures that use mining waste, changing the formula for calculating the viability of these structures, since currently only investments and operating costs are considered, but not the environmental impacts and benefits associated with the implementation of each structure. The use of waste will greatly reduce the risks and environmental impacts associated with the mine, dam and region as a whole.
iii. This system contributes to improving prevention of new dam failures, sewage treatment, erosion and flood control, water availability and the generation of jobs and income associated with a better water availability scenario, such as: power generation, irrigated agriculture, fish farming, tourism, among others.
iv. The structures also serve as safety barriers for possible new cases of tailings dam failures, as well as contributing to reducing erosion and improving flood control.
v. The reliefs improved by using this system can be used for various purposes, such as industrial, residential, commercial, and tourist areas, among others. In addition, they eliminate environmental liabilities caused by mining waste dams.

In analyzing the state of the art on the subject, document BR 10 2012 008758-8 is available, relating to a process for separating iron ore contained in waste from the extraction and processing of iron ore, which works with material below 2.0 mm in a first drying and grinding stage to extract the finer material, which is called clay. However, the fine material will have a high iron content and this will not be recovered in the process. The next stage is the separation of silica and iron ore, which will be wet and with magnetic separation. The proposed process route focuses on the processing of fine material, below 53 μm, and involves dewatering the material in a high-performance centrifuge using additives, reducing moisture to below 40%, feeding a selective grinding system that works on materials with a hardness of less than seven on the Mohz scale, integrated with a hot gas circulation system that allows the calcination of the material in suspension inside the mill, with a bottom extractor for the thicker and harder material and with aero classifiers to separate the finer and less dense materials from the thicker and denser ones. The entire process is dry, performs the pozzolanic activation of the clay in a single system and recovers the ultrafine iron ore, although the latter is not recovered in the aforementioned process.

In document BR 10 2012 008340-0, process and system for dry recovery of fine and superfine iron oxide ore, the focus is on the beneficiation of iron ore, unlike the process proposed here, which focuses on the beneficiation of the ultrafine fraction of mining waste and other residues (<150 μm). Other important aspects that differentiate the two technologies are: i) In the previous document, there is only drying to eliminate moisture; in this proposed process, the material is heated at higher temperatures to eliminate moisture, activate the pozzolanicity of non-metallic materials and facilitate the concentration of metallic materials; ii) In the process proposed here, selective grinding of fines is carried out, integrated with a hot gas system, which is highly energy efficient, and an initial pre-concentration is performed; iii) In the previous document, air classifiers are used only to separate the different particle size ranges that will feed the magnetic separators. In the process proposed herein, high-efficiency air classifiers are used to perform a second pre-concentration; iv) Material smaller than 10 μm is not considered a product in the system previously disclosed and this makes up a significant fraction of the sludge associated with mining waste, and which generally has the most interesting contents, precisely because it is more difficult to concentrate using traditional methods. The process proposed herein focuses precisely on the use of the sludge, including the fraction below 10 μm; v) The previous document only considers magnetic separation and without pre-concentration, while this process works with pre-concentration and other types of concentration systems for fines; vi) The previous document does not consider the use of non-metallic material. The process proposed herein transforms this ultrafine material into pozzolan and the fine material into sand. The same applies to documents BR 10 2014 012541-8, system and process for dry recovery of iron oxide fines from compact iron-bearing rocks; BR 10 2015 003408-3, system for dry recovery of iron oxide fines from compact and semi-compact iron-bearing rocks, on the main differences between the previous processes and the one proposed here.

In this same sense, document BR 10 2014 025420-0 is also cited, process and system for dry beneficiation of fine and superfine iron oxide ore through a magnetic separation unit, where the material is only dried to eliminate moisture. Although heat generation at a temperature of 850° C. is mentioned, the process temperature is not mentioned. In the process described herein, there is heating at higher temperatures to eliminate moisture, activate the pozzolanicity of non-metallic materials and to facilitate the concentration of metallic materials, with a process temperature of up to 750° C., depending on the material and the possible application.

Document BR 10 2014 002076-4, a process for extracting clay, silica and iron ore through dry concentration, only involves drying to eliminate moisture. In the process proposed herein, the material is heated at higher temperatures to eliminate moisture, activate the pozzolanicity of non-metallic materials and to facilitate the concentration of metallic materials, with a process temperature of up to 750° C., depending on the material and the possible application. Material smaller than 20 μm is not used in the previous system, as it is the clay fraction, but this makes up an important fraction of the sludge associated with mining waste, and which generally has the most interesting contents, precisely because it is more difficult to concentrate using traditional methods. The proposed process focuses precisely on the use of sludge, including fractions below 20 μm.

Document BR 11 2016 015408-8 discloses a method for processing tailings and a material processing system for processing tailings. The tailings include coarse waste rock, fine waste rock, coarse valuable product and fine valuable product. The material processing system comprises a classification element, a coarse flotation element and a fine flotation element arranged to separate the coarse valuable product, the coarse waste rock, the fine valuable product and the fine waste rock. The classification element separates the coarse waste rock and/or the coarse valuable product from the fine waste rock and/or the fine valuable product. The coarse flotation element separates the coarse waste rock from the coarse valuable product, the fine waste rock and/or the fine valuable product. The fine flotation element separates the fine valuable product from the coarse waste rock, the fine waste rock and/or the coarse valuable product. All processing is done wet, unlike the process proposed herein, where the material is processed dry.

Documents BR 1O 2016 011444-6 and BR 1O 2016 012293-7 present a flash calcination furnace and a process for treating mining waste/waste that uses this type of furnace. The process proposed herein does not use flash furnaces, but rather mills integrated with a hot gas generator. In addition, the process presented does not consider the use of a high-performance centrifuge for dewatering, pre-concentration in the grinding system, or subsequent concentration.

Document BR 10 2016 008663-9, treatment of ore processing waste containing water, does not calcine or concentrate the materials, unlike the process proposed herein, which also provides for an additive to aid in dewatering in a high-performance centrifuge and not in thickening as in the document cited.

Regarding document BR 10 2017 018466-8, a system for damming water using mining waste and using a bagwall, pre-concentration integrated into the grinding system is also not considered; only a pendulum mill and only magnetic concentration are considered. The process proposed herein provides for an additive to aid in dewatering in a high-performance centrifuge and not the simple use of a filter press.

Document BR 10 2017 026339-8, a process for the simultaneous treatment of mine waste smaller than 50 microns and recovery of residual minerals through magnetite-backed flocculation, despite focusing exclusively on fine material, fractions smaller than 50 μm, the concentration process is entirely wet and does not dry the clay, unlike the process proposed here in which the concentration is entirely dry and there is pozzolanic activation of the clays in a single system.

Documents BR 10 2019 009592-0, a process for the production of iron ore briquettes and including mining waste, and BR 10 2019 010712-0, a process for the disposal of waste from the iron ore beneficiation process in piles, do not deal with mineral concentration or pozzolanic activation of clay.

Document BR 11 2019 018299-3, process and apparatus for calcining and concentrating metal sulfide and/or residues, does not deal with mineral concentration or pozzolanic activation of clay; calcination is carried out in a fluidized bed.

Other documents may also be cited, such as PI 0709913-4 and PI 9003057-5, which present differences in relation to the process proposed here. In PI 0709913-4, there is no mineral concentration and the focus is on granulated material; in PI 9003057-5, work is done with a rotary tubular kiln.

### SUMMARY OF THE INVENTION

The sustainable system for processing fine mining waste, low-hardness ores, and industrial, electronic, and construction waste consists of integrating technologies to perform the steps required for the production of cement and recovery of materials of interest, usually metallic. The steps and technologies to be integrated depend on the type of material fed, the materials to be separated, and the applications of the materials produced.

### DESCRIPTION OF THE FIGURES

In order to better understand the present invention, the attached drawing is provided, where:

FIG. 1: is a flowchart that schematically represents the sustainable system for processing fine mining waste, low-hardness ores, and industrial, electronic, and construction waste in its input and output phases and products.

### DETAILED DESCRIPTION OF THE INVENTION

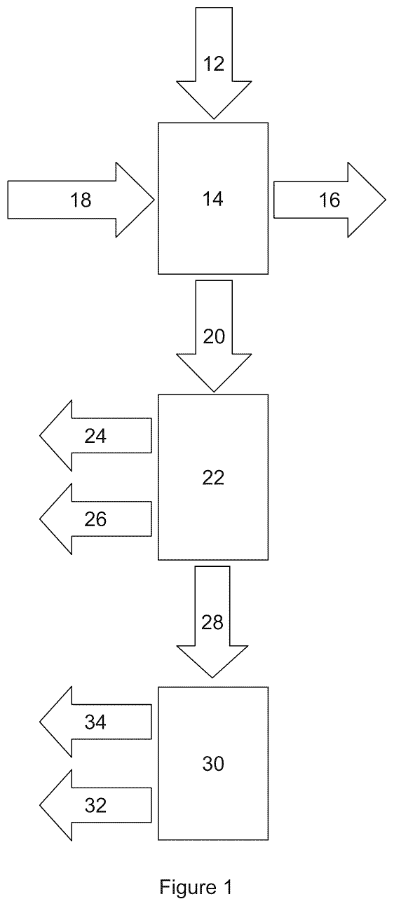

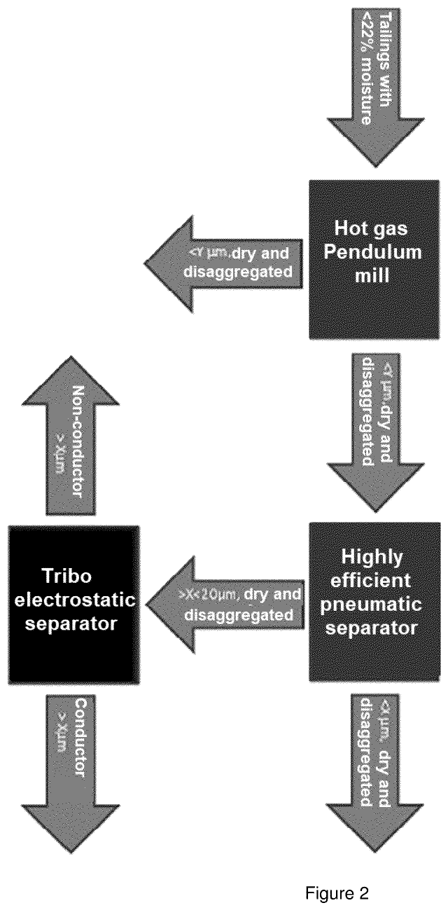

### List of Elements in FIGS. 1-2

12 Mud
14 High Performance Mineral Centrifuge
16 Water
18 Nanocomposite
20 Mud
22 Milling, Pozzolanic Activation, Fe reduction, and pre-concentration
24 Sand and Dense mat.
26 Light cement
28 Dense cement
30 Dry concentration System
32 Material of interest
34 Cement

The sustainable system for processing fine mining waste, low-hardness ores, and industrial, electronic, and construction waste is based on a process with five distinct phases, which have the following characteristics:
i. Dewatering: The use of oil well stimulants that reduce the tension of the liquid with the solid material improves the performance of high-performance centrifuges. In addition, integration with systems that can be fed with moisture content of 20% to 40% allows for new approaches to material processing.
ii. Drying, thermal activation, disaggregation and pre-concentration: These functions integrated into a single system and with high energy efficiency reduce investments and operating costs for processing and allow for new approaches to material processing with economic viability. This is the main innovation of this patent because, with this approach, the entire mass is heated and ground to aid in the release of minerals, to add value to the gangue and to facilitate the process of concentrating the minerals of interest.
iii. Stimulation of magnetism: The use of ultrasound to stimulate magnetism and its integration with the pre-concentration and thermal activation system, as an alternative to be considered in the search for greater energy efficiency and economic viability for the recovery of materials of interest.
iv. Magnetic separation: The use of magnetic separation to separate materials of interest and its integration with the pre-concentration and thermal activation system as an alternative to be considered in the search for greater energy efficiency and economic viability for the recovery of materials of interest. This type of process is already well known, however, the solution proposed here acts on the prior preparation of the material to facilitate its concentration.
v. Electrostatic or tribo-electrostatic separation: The use of electrostatic technologies to separate materials of interest and their integration with the pre-concentration and thermal activation system as an alternative to be considered in the search for greater energy efficiency and economic viability for the recovery of materials of interest. This type of process is already known, however, the solution proposed here works on the prior preparation of the material to facilitate its concentration.

The integration options for the process phases listed above are presented in Table 1 below:

TABLE 1
Route options for processing mineral waste

| Process | Technique | Option | Option | Option | Option | Option |
|---|---|---|---|---|---|---|
| step | status | 1 | 2 | 3 | 4 | 5 |
| Input | Wet fine | Wet fine | Wet fine | Wet fine | Wet fine | Wet fine |
| | tailings | tailings | tailings | tailings | tailings | tailings |
| | mixed with | | | | | |
| | sandy | | | | | |
| Dewatering | Press | High | High | High | High | High |
| | filter | performance | performance | performance | performance | performance |
| | | centrifugue + | centrifugue + | centrifugue + | centrifugue + | centrifugue + |
| | | oil well | oil well | oil well | oil well | oil well |
| | | stimulator | stimulator | stimulator | stimulator | stimulator |
| Drying | Dryer | Integrated | Integrated | Integrated | Integrated | Integrated |
| | set to | pendulum mill | pendulum mill | pendulum mill | impact mill | impact mill |
| | minimum | with hot gas | with hot gas | with hot gas | with hot gas | with hot gas |
| | drying | circulation | circulation | circulation | circulation | circulation |
| | temperature | (up to | (up to | (up to | (up to | (up to |
| Thermal | Not | 450° C.), | 450° C.), | 450° C.), | 750° C.), | 750° C.), |
| activation | used | capable of | capable of | capable of | capable of | capable of |
| Disaggregation | Disaggregator | accepting | accepting | accepting | accepting | accepting |
| | or | up to 22% | up to 22% | up to 22% | up to 40% | up to 40% |
| | conventional | moisture | moisture | moisture | moisture | moisture |
| | mill | feeding, | feeding, | feeding, | feeding, | feeding, |
| Segregation of | Vibrating | having a | having a | having a | having a | having a |
| non-milled | sieve | bottom | bottom | bottom | pneumatic | pneumatic |
| and dense | | extractor and | extractor and | extractor and | separator at | separator at |
| tailings | | pneumatic | pneumatic | pneumatic | the output | the output |
| Pre- | Not used | separator at | separator at | separator at | that pre- | that pre- |
| concentration | | the output | the output | the output | concentrates | concentrates |
| | | that pre- | that pre- | that pre- | by | by |
| | | concentrates | concentrates | concentrates | granulometry | granulometry |
| | | by | by | by | and density. | and density. |
| | | granulometry | granulometry | granulometry | | |
| | | and density. | and density. | and density. | | |
| Magnetism | Not used | Not used | System | Not used | Not used | Not used |
| stimulation | | | fitted with | | | |
| | | | Ultrasound | | | |
| Magnetic | Roller | Roller | Roller | Not used | Roller | Not used |
| separation | magnetic | magnetic | magnetic | | magnetic | |
| | separator | separator | separator | | separator | |
| Electrostatic | Not used | Not used | Not used | Electrostatic | Not used | Electrostatic |
| or tribo | | | | or tribo | | or tribo |
| electrostatic | | | | electrostatic | | electrostatic |
| separation | | | | separator | | separator |
| Output | Material | Material | Material | Material | Material | Material |
| | of interest + | of interest + | of interest + | of interest + | of interest + | of interest + |
| | sand and | fine sand + | fine sand + | fine sand + | fine sand + | fine sand + |
| | fines mixed | partially | partially | partially | activated | activated |
| | and dry | activated | activated | activated | cement, | cement, |
| | | cement, | cement, | cement, | all dry | all dry |
| | | all dry | all dry | all dry | | |

The routes presented in Table 1 may vary depending on the type of feed material and the potential applications for cement and sand, with a determining factor in defining the applications being the region in which the operation is located. There may also be variations in relation to the options presented, such as the elimination of steps, such as dewatering if moisture is accepted in the mill and the cost of dewatering is unfeasible.

These same routes can be used for the processing of low-hardness ores and industrial, electronic and construction waste.

The different products generated by the sustainable system for processing fine mining waste, low-hardness ores, and industrial, electronic, and construction waste, which vary according to the route chosen for the process, have the following characteristics:
i. Material of interest in recovery or decontamination: Minerals with a hardness below 7.0 on the Mohs scale will be ground to an ultrafine particle size, up to 97% smaller than 3.0 microns, which helps to release the minerals of interest. Magnetism and electrostatic contrast can be enhanced by exposing the material to process temperatures of 450° C. to 750° C. and by ultrasound, facilitating the concentration process. The temperature to be applied will depend on the characteristics of the material fed and its performance in the concentration process. Material with a hardness above 7.0 will not be comminuted and can be separated by the bottom extractor. Denser material can be pre-concentrated in the aero separator, reducing the mass to be worked on in the concentration.
ii. Ultrafine calcined material: Material with a hardness of less than 7.0 will be ground to an ultrafine particle size, up to 97% smaller than 3.0 microns, which aids in pozzolanic activation, and exposed to process temperatures of 450° C. to 750° C. The temperature to be applied will depend on the characteristics of the material fed and the demands of pozzolanic reactivity in the application of the resulting product.
iii. Dry sandy material: Material with a hardness greater than 7.0 will not be comminuted and will be segregated by the larger particle size. This material may be used as dry sand or sent to other processes depending on its chemical and mineralogical characteristics.

1. A system for processing a material including a fine mining tailing, low hardness ores, and industrial, electronic, or civil construction wastes to obtain a product, the system comprising i) a dewatering device; ii) a drying device, a thermal activation device, a disaggregation device, and a mass pre-concentration device; iii) an ultrasound device to stimulate magnetism; iv) a magnetic separation device; v) electrostatic or a tribo-electrostatic separation device.

2. The system according to claim 1, wherein the dewatering process is carried out by oil well stimulants.

3. The system according to claim 1, wherein the drying device, thermal activation device, the disaggregation device, and the pre-concentration device are integrated into a single system with high energy efficiency.

4. The system according to claim 1, wherein the an ultrasound device, magnetic separation device, and the electrostatic or tribo-electrostatic separation device are integrated into the pre-concentration and thermal activation system.

5. A product obtained by the system according to claim 1, the material to be separated is presented in the form of i) material of interest in recovery or decontamination; ii) ultrafine calcined material; and iii) dry sandy material.

6. The product according to claim 5, wherein the material and an ultrafine calcined material have a hardness below 7.0 on the Mohs scale, and present an ultrafine granulometry of up to 97% smaller than 3.0 microns.

7. The product according to claim 5, wherein the dry sandy material has a hardness greater than 7.0 on the Mohs scale, is segregated by the largest granulometry.
